(19) United States
(12) Patent Application Publication
(10) Pub. No.: US 2019/0144338 A1
(43) Pub. Date: May 16, 2019

(54) SELF-COOLING COMPOSITE MATERIALS

(71) Applicant: BASF SE, Ludwigshafen am Rhein (DE)

(72) Inventors: Bernd BRUCHMANN, Ludwigshafen (DE); Bernhard FEICHTENSCHLAGER, Trostberg (DE); Markus SCHUETTE, Lemfoerde (DE); Gerhard ALBRECHT, Prien am Chiemsee (DE); Patrick KASPER, Sexau (DE); Rolf MUELHAUPT, Freiberg (DE); Anoop GUPTA, Trostberg (DE); Eva GUENTHER, Trostberg (DE)

(21) Appl. No.: 16/097,491

(22) PCT Filed: Apr. 25, 2017
(86) PCT No.: PCT/EP2017/059808

§ 371 Date: Oct. 29, 2018

(30) Foreign Application Priority Data
May 4, 2016 (EP) 16168438.6

(51) Int. Cl. C04B 24/26; C04B 28/04; C04B 28/14; C04B 28/00; C04B 14/06; C04B 14/10; C04B 40/00

(52) U.S. Cl. CPC C04B 24/2688; C04B 28/04; C04B 28/14; C04B 2103/0051; C04B 14/06; C04B 14/104; C04B 40/0042; C04B 28/006

(57) ABSTRACT

The present invention relates to a composite material which comprises at least one thermoresponsive polymer and at least one inorganic building material. The present invention further relates to a method for producing the composite material and also to the use of the composite material for cooling and for regulating the humidity.

The present invention relates to a composite material which comprises at least one thermoresponsive polymer and at least one inorganic building material. The present invention further relates to a method for producing the composite material and also to the use of the composite material for cooling and for regulating the humidity.

Especially in regions with high daytime temperatures and high levels of insolation, there is a need to cool homes in order to create a pleasant environment for people. Conventional cooling using air-conditioning units often leads to high energy consumption. Given that the saving of energy is an important objective not least on account of the global warming, there is a need accordingly for less energy-consuming methods of cooling. Moreover, a cooling system that operates independently of electrical energy has the advantage of ensuring operational reliability. Facilities for which operational reliability is important include, for example, warehouses, refrigeration containers, self-sustaining telecommunication stations, or electrical facilities.

Various alternative cooling methods have been described in the prior art.

N. M. Nahar et al., Building and Environment 2003, 38, 109-116 and E. H. Amer, Energy 2006, 31, 1332-1344 describe various methods of cooling homes in regions with high insulation and hence also high temperatures. First of all, the roofs of the test houses are equipped with reflective materials such as white cement or white tiles, and, secondly, thermal insulation materials such as Vermiculite are used on or beneath the roof. Cooling is accomplished, furthermore, by evaporation of water, from jute sacks, for example, which are placed over the roof, or from water ponds which are located on the roof. The most efficient cooling is that from evaporation of water. However, the water evaporation cooling methods described in N. M. Nahar et al., Building and Environment 2003, 38, 109-111 and E. H. Amer, Energy 2006, 31, 1332-1344 require relatively large quantities of water, which, moreover, must be continually resupplied.

D. Karamanis, ICONCE 2014, 33-37 describes porous materials, especially clay minerals, which are able to store water in their micropores and evaporate water from these pores.

A. C. C. Rotzetter et al., Advanced Materials 2012, 24, 5352-5356 describe the use of poly(N-isopropylacrylamide) hydrogels for cooling buildings. In this case the poly(N-isopropylacrylamide) hydrogel is introduced as a film between a PVC film and a nanoporous polycarbonate membrane. Though the cooling effect of the poly(N-isopropylacrylamide) hydrogel is relatively good, relatively large quantities of poly(N-isopropylacrylamide) are needed on account of its use as a film. Furthermore, the film is very sensitive mechanically and cannot be deployed everywhere.

H.-Y. Chang et al., Renewable and Sustainable Energy Reviews 2010, 14, 781-789 describe various methods for passive cooling and heating of homes. Included in the description is cooling by evaporation of water. In that case, porous materials are employed as roofing material. These porous materials include siliceous rock, silica sand, volcanic ash, flint, mortar, and concrete.

Similarly S. van Veen and K. Magano, Building and Environment 2009, 44, 338-351 describe various methods for cooling homes, using porous and nonporous materials. The methods described in S. van Veen and K. Magano, Building and Environment 2009, 44, 338-351 also use flint, silica sand, volcanic ash, and siliceous rock as materials.

The methods described in H.-Y. Chang et al., Renewable and Sustainable Energy Reviews 2010, 14, 781-789 and in S. van Veen and K. Magano, Building and Environment 2009, 44, 338-351 for the passive cooling of homes are still in need of improvement.

US 2015/0291868 describes composite materials which are able to undergo phase transitions. These composite materials are nanostructured and contain both a thermoresponsive polymer and a nanocrystalline filler.

WO 2015/034475 describes a composite material which comprises a hydraulic cement, water, and a thermoresponsive polymer.

US 2014/0272282 describes a thermoresponsive construction for monitoring temperature build-up in solar panels. Employed in that case is a thermoresponsive layer comprising a thermoresponsive polymer and also an inorganic filler.

A disadvantage with the composite materials described in the prior art is that their cooling effect is in some cases unsatisfactory and, moreover, they are in some cases mechanically unstable, and in particular cannot be used as shaped articles.

There is therefore a need for composite materials capable of being used for cooling. The materials are to have the above-described disadvantages of the materials from the prior art to a reduced extent or not at all.

This object is achieved by means of a composite material which comprises the components

(A) at least one thermoresponsive polymer and
(B) at least one inorganic building material.

This object is further achieved by means of a composite material which comprises the components

(A) at least one thermoresponsive polymer and
(B) at least one inorganic building material,
the composite material further comprising a component (C), at least one clay mineral,
the component (A) having a lower critical solution temperature (LCST), the lower critical solution temperature (LCST) being in the range from 5 to 70° C., and
the component (B) being selected from the group consisting of hydraulically setting binders and nonhydraulically setting binders,
wherein the composite material comprises in the range from 5 to 45 wt % of component (A), in the range from 10 to 94.9 wt % of component (B), and in the range from 0.1 to 45 wt % of component (C), based in each case on the sum of the weight percentages of components (A), (B), and (C).

It has surprisingly been found that the composite material of the invention is able to accommodate more water and to release accommodated water more effectively than materials of the kind described in the prior art for example, than materials which contain only a thermoresponsive polymer, or materials which contain only an inorganic building material. The composite materials of the invention, therefore, are especially suitable for the cooling, for example, of buildings, of outdoor facilities, electrical facilities, primary or secondary batteries, through evaporation of water, and also for the regulation of humidity in interiors of buildings, but also of outdoor facilities, such as squares, streets, internal courtyards or terraces, for example.

It is advantageous, moreover, that water, particularly at temperatures above the lower critical solution temperature (LCST) of the at least one thermoresponsive polymer (component (A)), is released from the composite materials of the invention. Below the lower critical solution temperature (LCST) of component (A), only little or even no water is released from the composite materials of the invention, and so the cooling effect of the composite materials of the invention begins, in particular, only when higher temperatures are present, and hence when cooling is actually desired. If the component (A) has released its water above the LCST, it is able to accommodate water again, from the ambient air, for example, on falling below the LCST, and can then be utilized for cooling again.

It is advantageous, therefore, that the accommodation and release of water by the composite materials of the invention is reversible and can be controlled through the temperature. As a result of the reversible accommodation and release of water by the composite material, its cooling effect can be maintained even over long periods. The accommodation and release of water may be controlled through the natural heating and cooling phases of the ambient environment of the composite material.

The present invention is illustrated in more detail hereinafter.

### Composite Material

In accordance with the invention the composite material comprises components (A), at least one thermoresponsive polymer, and (B), at least one inorganic building material.

The terms “component (A)” and “at least one thermoresponsive polymer” are used synonymously in the context of the present invention, and therefore possess the same meaning.

The same is true of “component (B)” and “at least one inorganic building material”. These terms are likewise used synonymously in the context of the present invention, and therefore possess the same meaning.

The composite material of the invention comprises for example in the range from 0.5 to 50 wt % of component (A) and in the range from 50 to 99.5 wt % of component (B), based in each case on the sum of the wt % of components (A) and (B), preferably based on the overall weight of the composite material.

The composite material preferably comprises in the range from 5 to 45 wt % of component (A) and in the range from 55 to 95 wt % of component (B), based on the sum of the wt % of components (A) and (B), preferably based on the overall weight of the composite material.

The composite material more preferably comprises in the range from 20 to 40 wt % of component (A) and in the range from 60 to 80 wt % of component (B), based in each case on the sum of the wt % of components (A) and (B), preferably based on the overall weight of the composite material.

Component (A) of the composite material is customarily distributed within component (B) of the composite material.

Component (A) of the composite material may be distributed uniformly (homogeneously) or nonuniformly in component (B) of the composite material.

Preferably component (A) is distributed uniformly in component (B). In that case component (A) is in dispersion in component (B).

Component (A) is then the disperse phase, also called inner phase, and component (B) is the dispersion medium, also called continuous phase.

Another subject of the present invention, therefore, is a composite material which comprises component (A) distributed, preferably uniformly distributed, in component (B).

Yet another subject of the present invention is a composite material which comprises component (A) in dispersion in component (B).

The composite material of the invention preferably further comprises a component (C), at least one clay mineral.

Another subject of the present invention is therefore a composite material which further comprises a component

(C) at least one clay mineral.

The terms “component (C)” and “at least one clay mineral” are used synonymously in the context of the present invention, and therefore possess the same meaning.

In this embodiment the composite material comprises for example in the range from 0.5 to 50 wt % of component (A), in the range from 25 to 99.49 wt % of component (B), and in the range from 0.01 to 50 wt % of component (C), based in each case on the sum of the wt % of components (A), (B), and (C), preferably based on the overall weight of the composite material.

The composite material then preferably comprises in the range from 5 to 45 wt % of component (A), in the range from 10 to 94.9 wt % of component (B), and in the range from 0.1 to 45 wt % of component (C), based in each case on the sum of the wt % of components (A), (B), and (C), preferably based on the overall weight of the composite material.

The composite material then more preferably comprises in the range from 10 to 40 wt % of component (A), in the range from 20 to 89.5 wt % of component (B), and in the range from 0.5 to 20 wt % of component (C), based in each case on the sum of the wt % of components (A), (B), and (C), preferably based on the overall weight of the composite material.

Another subject of the present invention, therefore, is a composite material, said composite material comprising in the range from 0.5 to 50 wt % of component (A), in the range from 25 to 99.49 wt % of component (B) and in the range from 0.01 to 50 wt % of component (C), based in each case on the sum of the weight percentages of components (A), (B), and (C).

Where the composite material includes component (C), component (C) may for example, just like component (A), be distributed within component (B).

Preferably components (A) and (C) are uniformly distributed in component (B).

Where components (A) and (C) are uniformly distributed in component (B), components (A) and (C) are in dispersion in component (B).

In this embodiment it is possible for components (A) and (C) to form two separate disperse phases in the continuous phase of component (B). Preferably components (A) and (C) form a common disperse phase in the continuous phase of component (B). In this embodiment, the disperse phase comprises a mixture of components (A) and (C).

If components (A) and (C) are present in the form of a mixture, it is possible for component (C) to be uniformly distributed within component (A). It is also possible, and preferred in accordance with the invention, for component (C) to be disposed on the surface of component (A) and/or for component (A) to be disposed on the surface of component (C).

It is preferred, furthermore, for the composite material to further comprise water.

Another subject of the present invention is therefore a composite material which further comprises water.

The weight ratio of water present to the composite material is then situated, for example, in the range from 5:100 to 300:100, preferably in the range from 10:100 to 200:100, and especially preferably in the range from 20:100 to 100:100.

Where the composite material of the invention includes water, it is preferred for the water to be distributed in component (A) at temperatures below the lower critical solution temperature (LCST) of component (A). At temperatures above the lower critical solution temperature (LCST) of component (A), the water is preferably distributed within component (B) and is evaporated from that component and, in the process, delivered to the surroundings.

Furthermore, the composite material may also comprise further components. Such further components are known per se to the skilled person and are, for example, stabilizers, interface-active substances, flame retardants, or dyes.

The composite material may also additionally comprise further components which have been used in the preparation of component (A), such as, for example, comonomers, crosslinkers, stabilizers, and initiators. Further components which have been used in the preparation of component (A) are customarily contained in component (A) within the composite material.

The composite material comprises for example in the range from 0 to 50 wt % of the further components, preferably in the range from 0.5 to 20 wt %, and especially preferably in the range from 1 to 10 wt %, based in each case on the total weight of the composite material.

The composite material may further comprise a component (D), at least one organic binder.

Another subject of the present invention is therefore a composite material, said composite material comprising at least one component (D), at least one organic binder.

The composite material comprises for example in the range from 0.5 to 60 wt %, preferably in the range from 2 to 50 wt %, and especially preferably in the range from 5 to 40 wt % of component (D), based in each case on the total weight of the composite material.

The wt % figures for components (A) and (B) and also, optionally, for component (C), component (D), and the further components present in the composite material customarily add up to 100 wt %.

### Component (A)

In accordance with the invention, component (A) is at least one thermoresponsive polymer.

“At least one thermoresponsive polymer” for the purposes of the present invention means not only exactly one thermoresponsive polymer but also a mixture of two or more thermoresponsive polymers.

A thermoresponsive polymer is understood for the purposes of the present invention to be a polymer which changes its water-solubility sharply at a lower critical solution temperature (LCST). At temperatures below the lower critical solution temperature (LCST), the water solubility of the polymer is good, and the thermoresponsive polymer is preferably completely miscible with water, whereas at temperatures greater or equal to the lower critical solution temperature (LCST) its water solubility is poor.

It is possible for the thermoresponsive polymer also to have an upper critical solution temperature (UCST). In that case, at temperatures above the upper critical solution temperature (UCST), the water solubility of the thermoresponsive polymer is good, and preferably the thermoresponsive polymer is completely miscible with water. At temperatures below the upper critical solution temperature (UCST), the water solubility of the thermoresponsive polymer is poor; there is therefore a miscibility gap between the thermoresponsive polymer and water. This is also described for example in R. Liu, M. Fraylich and B. R. Saunders, Colloid. Poly. Sci. 2009, 287, 627-643 and V. Aseyev, H. Tenhu and F. M. Winnik, Adv. Polym. Sci. 2011, 242, 29-89.

The lower critical solution temperature (LCST) is therefore understood as the temperature at and above which the thermoresponsive polymer and water form two phases, the thermoresponsive polymer and water thus exhibiting a miscibility gap.

Another subject of the present invention, therefore, is a composite material wherein component (A) has a lower critical solution temperature (LCST), the lower critical solution temperature (LCST) being the temperature at which component (A) and water form two phases.

Expressed differently, a subject of the present invention is also a composite material wherein component (A) has a lower critical solution temperature (LCST), the lower critical solution temperature (LCST) being the temperature at which component (A) and water exhibit a miscibility gap.

Without wishing to confine the invention to this, the idea is that at temperatures below the lower critical solution temperature (LCST), the thermoresponsive polymer takes the form of an open-chain coil. As a result, water is easily able to penetrate the polymer chains and cause swelling of the polymer. At temperatures below the lower critical solution temperature (LCST), the interactions between the water and the polymer chains are energetically more advantageous than the interactions of the polymer chains with one another within the coil. In contrast thereto, at temperatures greater than or equal to the lower critical solution temperature (LCST), the thermoresponsive polymer takes the form of a collapsed coil and the interactions of the polymer chains with one another within the coil are energetically more advantageous than the interactions between the water and the polymer chains. The water is in that case displaced from the thermoresponsive polymer, and the thermoresponsive polymer takes the form of a compact coil. Differently expressed, this means that the thermoresponsive polymer gives up water at temperatures equal to or above the lower critical solution temperature (LCST).

In accordance with the invention, the lower critical solution temperature (LCST) is determined by differential scanning calorimetry (DSC) or by turbidity measurement. In this regard, see also V. Aseyev, H. Tenhu and F. M. Winnik, Adv. Polym. Sci. 2011, 242, 42 and R. Liu, M. Fraylich and B. R. Saunders, Colloid. Polym. Sci. 2009, 287, 630.

Component (A) customarily has a lower critical solution temperature (LCST), the lower critical solution temperature (LCST) being preferably in the range from 5 to 70° C., more preferably in the range from 10 to 60° C., and especially preferably in the range from 15 to 50° C., determined by differential scanning calorimetry (DSC) or turbidity measurement.

Another subject of the present invention is therefore a composite material wherein component (A) has a lower critical solution temperature (LCST), the lower critical solution temperature (LCST) being in the range from 5 to 70° C.

Component (A) customarily has a glass transition temperature (T_{g(A)}). The glass transition temperature (T_{g(A)}) of component (A) is situated for example in the range from 15 to 150° C., preferably in the range from 20 to 100° C., and especially preferably in the range from 30 to 100° C., determined by differential scanning calorimetry (DSC). In this regard, see also DIN 53765 and DIN 51007.

It is self-evident that the glass transition temperature (T_{g(A)}) of component (A) refers to the water-free component (A). The glass transition temperature (T_{g(A)}) of component (A) therefore refers to the glass transition temperature (T_{g(A)}) of the pure component (A).

Furthermore, component (A) customarily has a melting temperature (T_{m(A)}). The melting temperature of component (A) Is situated customarily m the range from 20 to 250° C., preferably m the range from 25 to 200° C., and especially preferably in the range from 50 to 180° C. determined by differential scanning calorimetry (DSC). In this regard see also DIN 53765.

Suitable as component (A) are all polymers which are thermoresponsive in the sense of the present invention. Component (A) is preferably selected from the group consisting of poly(meth)acrylates, poly(meth)acrylamides, poly(meth)acryloylpyrrolidines, poly(meth)acryloylpiperidines, poly-N-vinylamides polyoxazolines, polyvinyloxazolidones, polyvinylcaprolactones, polyvinylcaprolactams, polyethers, hydroxypropylcelluloses, polyvinyl ethers, and polyphosphoesters. Component (A) is preferably selected from the group consisting of poly(meth)acrylates, poly(meth)acrylamides, poly-N-vinylamides, polyoxazolines, polyvinylcaprolactams polyethers, hydroxypropylcelluloses, and polyvinyl ethers.

In another preferred embodiment, component (A) is selected from the group consisting of poly(meth)acrylates, poly(meth)acrylamides, poly(meth)acryloylpyrrolidines, poly(meth)acryloylpiperidines, poly-N-vinylamides, polyoxazolines, polyvinyloxazolidones, polyvinylcaprolactones, polyvinylcaprolactams, polyethers, polyvinyl ethers, and polyphosphoesters. Component (A) is preferably selected from the group consisting of poly(meth)acrylates poly(meth)acrylamides, poly-N-vinylamides, polyoxazolines, polyvinylcaprolactams, polyethers, and polyvinyl ethers.

Another subject of the present invention, therefore, is a composite matenal wherein component (A) is selected from the group consisting of poly(meth)acrylates, poly(meth)acrylamides, poly(meth)acryloylpyrrolidines, poly(meth)acryloylpiperidines, poly-N-vinylamides, polyoxazolines, polyvinyloxazolidones, polyvinylcaprolactones, polyvinylcaprolactams, polyethers, hydroxypropylcelluloses, polyvinyl ethers, and polyphosphoesters.

Poly(meth)acrylates are understood m the context of the present invention to refer not only to polyacrylates but also to polymethacrylates, and also copolymers thereof with other monomers

Suitable poly(meth)acrylates are known as such to the skilled person. The poly(meth)acrylates are preferably selected from the group consisting of poly(methy) 2-isobutyracrylate), poly[2-(dimethylamino)ethyl methacrylate] (PDMAEMA), poly[2 (2-ethoxyethoxy)ethyl acrylate) (PEEO2A), poly(2-(2-methoxyethoxy)ethyl methacrylate] (PMEO2MA), poly(2-hydroxypropyl acrylate) (PHPA), polyhydroxyethyl methacrylate (polyHEMA), and methoxy-terminated dendronized poly(meth)acrylates. Preferred poly(meth)acrylates are selected from the group consisting of poly(methyl 2-isobutyracrylate), poly[2-(dimethylamino)ethyl methacrylate] (PDMAEMA), poly[2-(2-ethoxyethoxy)ethyl acrylate] (PEEO2A), poly[2-(2-methoxyethoxy)ethyl methacrylate] (PMEO2MA), and poly(2-hydroxypropyl acrylate) (PHPA).

Alkoxy-terminated hyperbranched poly(meth)acrylates may also be used.

Poly(meth)acrylamides for the purposes of the present invention are understood to be polyacrylamides, polymethacrylamides, and also copolymers thereof with other monomers. They are known as such to the skilled person. For example, poly(meth)acrylamides are selected from the group consisting of poly(N-n-propylacrylamide) (PnPAAm), poly(N-isopropylacrylamide) (PNiPAAm), poly(N-n-propylmethacrylamide) (PnPMAAm), poly(N-isopropylmethacrylamide) (PiPMAAm), poly(N-(L)-(1-hydroxymethyl)propylmethacrylamide) (P(L-HMPNAAm)), poly(N,N-diethylacrylamide) (PDEAAm), poly(N,N-ethylmethylacrylamide) (PNNEMAAm), poly(N-ethylmethacrylamide) (PNEMAAm), poly(N-ethylacrylamide) (PEAAm), poly(N-ethylmethacrylamide) (PEMAAm) and poly(N-cyclopropylacrylamide) (PcPAAm). Preferred poly(meth)acrylamides are selected from the group consisting of poly(N-n-propylacrylamide) (PnPAAm), poly(N-isopropylacrylamide) (PNiPAAm), poly(N-n-propylmethacrylamide) (PnPMAAm), poly(N-(L)-(1-hydroxymethyl)propylmethacrylamide) (P(L-HMPNAAm)), poly(N,N-diethylacrylamide) (PDEAAm), poly(N-ethylmethacrylamide) (PEMAAm) and poly(N-cyclopropylacrylamide) (PcPAAm).

The designation poly(meth)acryloylpyrrolidines encompasses, for the purposes of the present invention, not only polymethacryloylpyrrolidines but also polyacryloylpyrrolidines, and also copolymers thereof with other monomeres. They are known as such to the skilled person. A preferred poly(meth)acryloylpyrrolidine in accordance with the invention is poly(N-acryloylpyrrolidine).

For the purposes of the present invention, poly(meth)acryloylpiperidines encompass not only polyacryloylpiperidines but also polymethacryloylpiperidines, and also copolymers thereof with other monomeres. A preferred poly(meth)acryloylpiperidine is poly(N-acryloyl)piperidine (PAOPip).

Poly-N-vinylamides are known to the skilled person and are selected for example from the group consisting of poly(N-vinylpropylacetamide) and poly(N-vinylisobutyramide) (PViBAm).

As polyoxazolines it is possible to use all polyoxazolines known to the skilled person. The polyoxazolines are selected for example from the group consisting of poly(2-n-propyl-2-oxazoline) (PnPOz) and poly(2-isopropyl-2-oxazoline) (PiPOz).

Polyvinyloxazolidones are known to the skilled person. An example of a suitable polyvinyloxazolidone is poly(N-vinyl-5-methyl-2-oxazolidone).

Suitable polyvinylcaprolactones are known to the skilled person. Preference is given to poly(N-vinyl)caprolactone and copolymers thereof.

Suitable polyvinylcaprolactams are likewise known per se to the skilled person, an example being poly(N-vinylcaprolactam) (PVCL).

Suitable polyethers are known to the skilled person. The polyethers are selected for example from the group consisting of poly(ethylene glycol) (PEG), polyethylene glycol-polypropylene glycol copolyethers, hydrophobically endcapped poly(ethylene oxide-co-propylene oxide) and hyperbranched polyethers. The polyethers are preferably terminated by hydrophobic groups.

Suitable hydroxypropylcelluloses are known to the skilled person, examples being hydroxypropylcellulose (HPC) and hydroxypropylmethylcellulose (HPMC).

The preparation of hydroxypropylcellulose and hydroxypropylmethylcellulose is common knowledge to the skilled person, for example, through reaction of cellulose or methylcellulose with propylene oxide.

Suitable polyvinyl ethers are known as such to the skilled person and are selected for example from the group consisting of poly(methyl vinyl ether) (PMVEth), poly(2-methoxyethyl vinyl ether) (PMOVEth), poly(2-ethoxyethyl vinyl ether) (PEOVEth), poly(2-(2-ethoxy)ethoxyethyl vinyl ether), and poly(4-hydroxybutyl vinyl ether).

Also suitable are homopolymers and copolymers prepared from oligovinyl ethers, such as ethylene oxide vinyl ether, propylene oxide vinyl ether or n-butylene oxide vinyl ether.

Suitable polyphosphoesters are likewise known to the skilled person and are selected for example from the group consisting of poly(2-ethoxy-2-oxo-1,3,2-dioxaphospholane) and poly(2-isopropoxy-2-oxo-1,3,2-dioxaphospholane). Poly(2-ethoxy-2-oxo-1,3,2-dioxaphospholane) is also known by the name poly(ethylethylene phosphate). Poly(2-isopropoxy-2-oxo-1,3,2-dioxaphospholane) is also known under the name poly(isopropylethylene phosphate).

With particular preference, therefore, component (A) is selected from the group consisting of poly(methyl 2-isobutyracrylate), poly[2-(dimethylamino)ethyl methacrylate] (PDMAEMA), poly[2-(2-ethoxyethoxy)ethyl acrylate] (PEEO2A), poly[2-(2-methoxyethoxy)ethyl methacrylate] (PMEO2MA), poly(2-hydroxypropyl acrylate) (PHPA), poly(N-n-propylacrylamide) (PnPAAm), poly(N-isopropylacrylamide) (PNiPAAm), poly(N-n-propylmethacrylamide) (PnPMAAm), poly(N-(L)-(1-hydroxymethyl)-propylmethacrylamide) (P(L-HMPNAAm)), poly(N,N-diethylacrylamide) (PDEAAm), poly(N-ethylmethacrylamide) (PEMAAm), poly(N-cyclopropylacrylamide) (PcPAAm), poly(N-vinylpropylacetamide), poly(N-vinylisobutyramide) (PViBAm), poly(2-n-propyl-2-oxazoline) (PnPOz), poly(2-isopropyl-2-oxazoline) (PiPOz), polyvinylcaprolactam (PVCL), polyethylene glycols (PEG), polyethylene glycol-polypropylene glycol copolyethers, hydrophobically endcapped poly(ethylene oxide-co-propylene oxide) polyethers, hyperbranched polyethers, hydroxypropylcellulose (HPC), poly(methyl vinyl ether) (PMVEth), poly(2-methoxyethyl vinyl ether) (PMOVEth), poly(2-ethoxyethyl vinyl ether) (PEOVEth), poly(2-(2-ethoxy)ethoxyethyl vinyl ether), and poly(4-hydroxybutyl vinyl ether).

### Component (B)

In accordance with the invention, component (B) is at least one inorganic building material.

For the purposes of the present invention, “at least one inorganic building material” refers both to exactly one inorganic building material and also to a mixture of two or more inorganic building materials.

Inorganic building materials are known to the skilled person and are, for example, ceramic building materials, glass building materials, natural building materials, slags, metallic building materials, and binders. Component (B) is preferably selected from binders.

Binders are known as such to the skilled person. Customarily a distinction is made between hydraulically setting binders and nonhydraulically setting binders.

It is therefore especially preferred for component (B) to be selected from the group consisting of hydraulically setting binders and nonhydraulically setting binders.

Another subject of the present invention is therefore a composite material wherein component (B) is selected from the group consisting of hydraulically setting binders and nonhydraulically setting binders.

Hydraulically setting binders are understood to be binders which are able to cure both in air and under water. In contrast to these, nonhydraulically setting binders are understood to be binders which are able to cure only in air, but not under water. Nonhydraulically setting binders are customarily not water-resistant after fully curing.

“Setting” is understood for the purposes of the present invention to be the transition from the liquid to the solid state, this transition being attributable to chemical processes, i.e., the formation of chemical bonds. When component (B) sets, then, it undergoes transition to the solid state. This is also referred to as curing.

The hydraulically setting binders include, for example, cement and gypsum; the nonhydraulically setting binders include, for example, aluminosilicates, nonhydraulic lime, waterglasses, and magnesia binders. Magnesia binders are also known under the name magnesite binders.

The above-described hydraulically setting binders and nonhydraulically setting binders are known as such to the skilled person.

It is particularly preferred in accordance with the invention, therefore, for component (B) to be selected from the group consisting of cement, gypsum, aluminosilicates, nonhydraulic lime, waterglasses and magnesia binders.

The at least one inorganic building material used as component (B), preferably the at least one binder, may be used in pure form or as part of a mixture, such as, for example, plaster, mortar or concrete, in the composite material of the invention. In that case, component (B) then comprises, for example, further aggregates such as, for example, sands, finely ground rocks, microsilica, fly ashes, slags, glass, natural stone, ceramic and/or pozzolan, and also, optionally, additives such as foam formers, water reducers, defoamers, thickeners and/or dispersants. These aggregates and additives are known to the skilled person.

Plasters are based generally on cement or gypsum as component (B) and have predominantly decorative function when used as building material.

Mortars are based in general on cement as component (B) and comprise sand and/or aggregates, in each case with a particle size of <4 mm.

Concretes are based generally on cement as component (B) and comprise aggregates having a particle size of >4 mm.

For use as building material, more particularly as binder, component (B) is customarily mixed with water. This water is also referred to as mixing water. This mixture is then, for example, cast in a mold, applied as plaster to a wall or introduced into interstices in masonry, and subsequently cured. This method is known to the skilled person.

As described above, “setting” and “curing” refer to the transition from the liquid to the solid state, the transition to the solid state being attributable to chemical reactions. To the skilled person it is clear that the composite material may therefore comprise component (B) in cured form and hence in reacted form.

### Component (C)

In one preferred embodiment of the invention, the composite material further comprises a component (C), at least one clay mineral.

“At least one clay mineral” for the purposes of the present invention means either exactly one clay mineral or else a mixture of two or more clay minerals.

“Clay minerals” for the purposes of the present invention are inorganic materials of layered construction. Inorganic materials of layered construction are known as such to the skilled person. Preferred inorganic materials of layered construction are layered silicates.

Component (C) is therefore preferably at least one inorganic material of layered construction, more preferably at least one layered silicate.

Another subject of the present invention, then, is a composite material wherein component (C) is an inorganic material of layered construction.

The layered silicates particularly preferred in accordance with the invention are known as such to the skilled person.

Layered silicates customarily comprise silicon atoms surrounded tetrahedrally (coordinated) by oxygen atoms. Particularly preferred in accordance with the invention are layered silicates which additionally comprise aluminum atoms surrounded octahedrally (coordinated) by oxygen atoms. Furthermore, layered silicates customarily comprise further elements, such as sodium, barium or calcium, for example.

In the layered silicates, the silicon atoms coordinated tetrahedrally by oxygen atoms are customarily disposed in layer form (tetrahedral layer). Similarly, the aluminum atoms coordinated octahedrally by oxygen atoms are customarily disposed in layer form (octahedral layer). In the layered silicates, the octahedral layers may alternate with the tetrahedral layers; it is also possible, for example, for an octahedral layer to follow two tetrahedral layers.

Water may be intercalated between the layers of the at least one clay mineral. As a result, the at least one clay mineral is swollen. The intercalation of water into the layers of the at least one clay mineral is reversible, meaning that the water between the layers may be removed again by drying.

Component (C) is therefore preferably swellable.

“Swellable” for the purposes of the present invention therefore means that component (C) is able to intercalate water between the layers and that this water can be removed again from the space between the layers by drying.

If water has been intercalated between the layers of component (C), component (C) is in a swollen state. If there is no water intercalated between the layers of component (C), component (C) is unswollen.

It is self-evident that component (C) is different from component (B).

In contrast to component (B), component (C) preferably has no setting properties. Preferably, therefore, component (C) is not a binder.

Another subject of the present invention is therefore a composite material wherein component (C) has no setting properties.

“Setting” for the purposes of the present invention, as already described above, is understood as the transition from the liquid to the solid state, the transition being attributable to chemical processes, i.e., the formation of chemical bonds. If component (C) sets, therefore, it undergoes transition to the solid state. This is also referred to as curing. Preferably component (C) does not set, and therefore, preferably, component (C) does not cure.

Component (C) is preferably selected from the group consisting of montmorillonites and kaolinites.

Another subject of the present invention is therefore a composite material wherein component (C) is selected from the group consisting of montmorillonites and kaolinites. Component (C) may be used as the pure at least one clay mineral. Component (C) is preferably used in the form of rock which contains the at least one clay mineral, optionally also as a mixture with other accompanying minerals, such as mica, quartz, feldspar, pyrite and/or calcite, for example.

Rocks which comprise the at least one clay mineral are known to the skilled person and are, for example, kaolin and bentonite.

If component (C) is therefore used as rock, then component (C) is preferably selected from the group consisting of kaolin and bentonite.

Another subject of the present invention is therefore a composite material wherein component (C) is selected from the group consisting of kaolin and bentonite.

Kaolin is known as such to the skilled person. The main constituent of kaolin is the mineral kaolinite. Furthermore, kaolin may also comprise other minerals. For the purposes of the present invention, the term “kaolin”, moreover, also refers to the thermally activated variants of kaolin, such as metakaolin for example.

Bentonite is likewise known to the skilled person. The main constituent of bentonite is montmorillonite. In addition, bentonite may further comprise quartz, mica, feldspar, pyrite or calcite, for example.

### Component (D)

In accordance with the invention, component (D) is at least one organic binder.

“At least one organic binder” in the context of the present invention means not only exactly one organic binder but also a mixture of two or more organic binders.

The terms “component (D)”, and “at least one organic binder” are used synonymously for the purposes of the present invention and therefore possess the same meaning.

In the case of the organic binders (component (D)), a distinction is made between purely physically curing organic binders and those which cure by chemical reaction. Purely physically curing organic binders are solutions of polymers in organic solvents and/or water. Curing occurs by removal of the water and/or the organic solvent, customarily by evaporation. Organic binders curable by chemical reactions are monomeric, oligomeric or polymeric compounds having groups chemically reactive with one another, which are introduced into the composite material in pure form or as a solution in water or in a suitable solvent. The reactive groups then ensure, by means of a chemical reaction, that the organic binder undergoes curing to form polymeric structures over a period of a few hours up to 30 days. The organic binder may be used here as a one-component system or as a two-component or multicomponent system. In the case of one-component systems, the monomeric, oligomeric or polymeric compounds having groups chemically reactive with one another are present alongside one another in the system. The groups chemically reactive with one another are in that case activated for reaction via a switching or trigger mechanism—for example, by change in pH, by irradiation with shortwave light, by supply of heat, or by oxidation with atmospheric oxygen. In the case of two-component or multicomponent systems, the monomeric, oligomeric or polymeric compounds having groups chemically reactive with one another are initially present separately. The organic binder is activated only on mixing of the components, and the development of molecular weight can be accomplished by chemical reactions. It is of course also possible for combinations of physical curing and curing through chemical reaction to take effect in the organic binder.

Suitable organic binders are known to the skilled person; for example, polyurethanes, polyureas, polyacrylates, polystyrenes, polystyrene copolymers, polyvinyl acetates, polyethers, alkyd resins or epoxy resins can be used. The organic binders are different from the thermoresponsive polymer (A) and have no LCST.

Physically curing organic binders that are suitable are aqueous dispersions, examples being acrylate dispersions, ethylene-vinyl acetate dispersions, polyurethane dispersions or styrene-butadiene dispersions. Examples of suitable chemically curing one-component systems are polyurethanes or alkyd resins. Examples of chemically curing two-component or multicomponent systems that can be used are epoxy resins, polyurethanes, and polyureas. Organic binders which may feature a combination of physical curing and curing through chemical reaction are, for example, postcrosslinking acrylate dispersions or postcrosslinking alkyd resin dispersions.

Physically curing organic binders are customarily film-forming; binders which cure through chemical reaction customarily cure by crosslinking.

The organic binders may be used in such a way that they cure during production of the composite material; it is also possible for component (D) to be used in a cured form, as compact material or in foamed form, for example.

### Production of the Composite Material

The composite material of the invention may be produced by any methods known to the skilled person. The composite material of the invention is preferably produced by a method comprising the following steps:
a) providing a mixture (M) which comprises the at least one thermoresponsive polymer (A),
b) mixing the mixture (M) with component (B) to give the composite material.

Another subject of the present invention, therefore, is a method for producing a composite material of the invention, comprising the steps of
a) providing a mixture (M) which comprises the at least one thermoresponsive polymer (A),
b) mixing the mixture (M) with component (B) to give the composite material.

The mixture (M) provided in step a) comprises component (A). The mixture (M) may, furthermore, comprise further components. The mixture (M) preferably further comprises a component (C)—at least one clay mineral.

Another subject of the present invention is therefore a method wherein the mixture (M) provided in step a) further comprises at least one clay mineral (C).

A further subject of the present invention is a method for producing a composite material of the invention, comprising the steps of
a) providing a mixture (M) which comprises the at least one thermoresponsive polymer (A),
b) mixing the mixture (M) with component (B) to give the composite material,
   wherein the mixture (M) provided in step a) further comprises at least one clay mineral (C).

Component (C) preferably included additionally in the mixture (M) is subject to the above-described embodiments and preferences for the component (C) optionally included in the composite material, mutatis mutandis.

Where the mixture (M) provided in step a) further includes at least one clay mineral (C), the mixture (M) comprises for example in the range from 10 to 99.5 wt % of component (A) and in the range from 0.5 to 90 wt % of component (C), based in each case on the sum of the weight percentages of components (A) and (C), preferably based on the overall weight of the mixture (M).

In that case the mixture (M) preferably comprises in the range from 50 to 99 wt % of component (A) and in the range from 1 to 50 wt % of component (C), based in each case on the sum of the weight percentages of components (A) and (C), preferably based on the overall weight of the mixture (M).

In that case the mixture (M) especially preferably comprises in the range from 70 to 95 wt % of component (A) and in the range from 5 to 30 wt % of component (C), based in each case on the sum of the weight percentages of components (A) and (C), preferably based on the overall weight of the mixture (M).

The mixture (M) comprises the at least one thermoresponsive polymer (A) preferably in the form of particles, and also comprises the at least one clay mineral (C) preferably in the form of particles. The particles of the at least one thermoresponsive polymer (A) have for example a D50 in the range from 200 nm to 5 mm; the particles of the at least one clay mineral (C) have for example a D50 in the range from 50 nm to 3 mm, determined by light scattering and/or sieving.

The particles of the at least one thermoresponsive polymer (A) preferably have a D50 in the range from 300 nm to 4 mm, and the particles of the at least one clay mineral (C) preferably have a D50 in the range from 50 nm to 1 mm, determined by light scattering and/or sieving.

The particles of the at least one thermoresponsive polymer (A) especially preferably have a D50 in the range from 500 nm to 3 mm, and the particles of the at least one clay mineral (C) preferably have a D50 in the range from 100 nm to 0.5 mm, determined by light scattering and/or sieving.

Another subject of the present invention is therefore a method wherein the mixture (M) provided in step a) comprises the at least one thermoresponsive polymer (A) in the form of particles and comprises the at least one clay mineral (C) in the form of particles, the particles of the at least one thermoresponsive polymer (A) having a D50 in the range from 200 nm to 5 mm, and the particles of the at least one clay mineral (C) having a D50 in the range from 50 nm to 3 mm, determined by light scattering and/or sieving.

The “D50” is understood as the particle size at which 50 vol % of the particles, based on the total volume of the particles, are smaller than or equal to the D50 value and 50 vol % of the particles, based on the total volume of the particles, are larger than the D50 value.

The mixture (M) may further comprise at least one dispersion medium. A preferred dispersion medium is water.

Preferably the mixture (M) contains no water, and especially preferably the mixture (M) contains no dispersion medium.

It is therefore preferred for the mixture (M) provided in step a) to be dry.

“Dry” in the context of the present invention means that the mixture (M) contains less than 10 wt %, preferably less than 5 wt %, and more preferably less than 3 wt % of water, and especially preferably the mixture (M) contains less than 10 wt %, preferably less than 5 wt %, and especially preferably less than 3 wt % of dispersion medium, based in each case on the total weight of the mixture (M).

The mixture (M) may be provided in step a) by any methods known to the skilled person. The mixture (M) in step a) is preferably provided by polymerization of at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers or phosphoesters. The polymerization of the at least one monomer gives the at least one thermoresponsive polymer (A).

The mixture (M) in step a) is more preferably provided by polymerization of at least one monomer selected from the group consisting of (meth)acrylates, (meth)acrylamides, (meth)acryloylpyrrolidines, (meth)acryloylpiperidines, N-vinylamides, vinyloxazolidones, vinylcaprolactones, vinylcaprolactams, and vinyl ethers.

These polymerizations are known to the skilled person and are, for example, radical chain-growth polymerizations, polyadditions or polycondensations.

Another subject of the present invention is therefore a method wherein the providing of the mixture (M) in step a) comprises a polymerization of at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters, to give the at least one thermoresponsive polymer (A).

(Meth)acrylates for the purposes of the present invention encompass both acrylates and methacrylates. Suitable (meth)acrylates are known as such to the skilled person and are selected for example from the group consisting of methyl 2-isobutyracrylate, 2-(dimethylamino)ethyl methacrylate, 2-(2-ethoxyethoxy)ethyl acrylate, 2-(2-methoxyethoxy)ethyl methacrylate, 2-hydroxyethyl methacrylate, and 2-hydroxypropyl acrylate.

The term (meth)acrylamides for the purposes of the present invention encompasses both acrylamides and methacrylamides. Suitable (meth)acrylamides are selected for example from the group consisting of N-(n-propyl)acrylamide, N-isopropylacrylamide, N-(n-propyl)methacrylamide, N-isopropylmethacrylamide, N-(L)-1-hydroxymethylpropyl-methacrylamide, N,N-diethylacrylamide, N,N-ethylmethacrylamide, and N-cyclopropylacrylamide.

The term (meth)acryloylpyrrolidines for the purposes of the present invention encompasses both acryloylpyrrolidines and methacryloylpyrrolidines. Preferred (meth)acryloylpyrrolidines are N-acryloylpyrrolidines.

(Meth)acryloylpiperidines for the purposes of the present invention are both acryloylpiperidines and methacryloylpiperidines. Preferred (meth)acryloylpiperidines are N-acryloylpiperidines.

Suitable N-vinylamides are known as such to the skilled person and are, for example, N-vinylpropylacetamide or N-vinylisobutyramide.

Suitable oxazolines are likewise known to the skilled person and are selected for example from the group consisting of 2-(n-propyl)-2-oxazoline and 2-isopropyl-2-oxazoline.

Suitable vinyloxazolidones are likewise known to the skilled person. A preferred vinyloxazolidone is N-vinyl-5-methyl-2-oxazolidone.

Suitable vinylcaprolactones are also known to the skilled person, as are vinylcaprolactams.

Suitable alkylene oxides are likewise known to the skilled person and are selected for example from the group consisting of ethylene oxide and propylene oxide.

Suitable vinyl ethers are likewise known to the skilled person and are selected for example from the group consisting of methyl vinyl ether, 2-methoxyethyl vinyl ether, 2-ethoxyethyl vinyl ether, 2-(2-ethoxy)ethoxyethyl vinyl ether, and 4-hydroxybutyl vinyl ether.

Suitable phosphoesters are known to the skilled person and are, for example, 2-ethoxy-2-oxo-1,3,2-dioxaphospholane and 2-isopropoxy-2-oxo-1,3,2-dioxaphospholane.

If the at least one thermoresponsive polymer (A) is a copolymer, it is self-evident that for the purpose of providing the mixture (M) in step a), at least one comonomer is used in addition to the at least one monomer. Such comonomers are known to the skilled person and are, for example, styrene, methylstyrene, C₁-C₆ alkyl acrylates, divinylbenzene, diacrylates, preferably based on C₂ to C₆ diols, N,N-methylenebisacrylamide or [3-(methacryloylamino)propyl]trimethylammonium chloride.

If the mixture (M) provided in step a) further comprises a component (C), it is preferred for the polymerization of the at least one monomer to take place in the presence of the at least one clay mineral (C).

Another subject of the present invention, therefore, is a method wherein the providing of the mixture (M) in step a) comprises a polymerization of at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters, to give the at least one thermoresponsive polymer (A) in the presence of the at least one clay mineral (C).

The at least one monomer may be polymerized by any methods known to the skilled person. Suitable methods for polymerizing the at least one monomer are, for example, a radical chain-growth polymerization, a polyaddition or a polycondensation.

The polymerization takes place preferably by radical chain-growth polymerization in the presence of an initiator.

The providing of the mixture (M) in step a), if the mixture (M) provided further comprises at least one clay mineral (C), preferably comprises the following steps
a1) providing a first dispersion which comprises the at least one clay mineral (C), a dispersion medium selected from the group consisting of water and an organic solvent, and at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters,
a2) polymerizing the at least one monomer present in the first dispersion provided in step a1), in the first dispersion, to give the at least one thermoresponsive polymer (A), to give a second dispersion which comprises the at least one clay mineral (C), the dispersion medium, selected from the group consisting of water and an organic solvent, and the at least one thermoresponsive polymer (A),
a3) drying the second dispersion obtained in step a2) to give the mixture (M).

Another subject of the present invention, therefore, is a method wherein the providing of the mixture (M) in step a) comprises the following steps:
a1) providing a first dispersion which comprises the at least one clay mineral (C), a dispersion medium selected from the group consisting of water and an organic solvent, and at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters,
a2) polymerizing the at least one monomer present in the first dispersion provided in step a1), in the first dispersion, to give the at least one thermoresponsive polymer (A), to give a second dispersion which comprises the at least one clay mineral (C), the dispersion medium, and the at least one thermoresponsive polymer (A),
a3) drying the second dispersion obtained in step a2) to give the mixture (M).

“A dispersion medium” for the purposes of the present invention refers both to exactly one dispersion medium and to a mixture of two or more dispersion media.

In accordance with the invention the dispersion medium is selected from water and organic solvent, and preferably the dispersion medium is water.

For the organic solvent which may be used as the dispersion medium, all organic solvents known to the skilled person are suitable. Preference is given to low-boiling organic solvents, with “low-boiling organic solvents” referring to organic solvents which having a boiling temperature of <140° C. Organic solvents of this kind are known to the skilled person and are selected for example from the group consisting of methanol, ethanol, toluene, tetrahydrofuran, xylene, ethyl ester, and butyl acetate.

A first dispersion provided in step a1) is preferably a dispersion which comprises the at least one clay mineral (C), the dispersion medium, and at least one monomer selected from the group consisting of (meth)acrylates, (meth)acrylamides, (meth)acryloylpyrrolidines, (meth)acryloylpiperidines, N-vinylamides, vinyloxazolidones, vinylcaprolactones, vinylcaprolactams, and vinyl ethers.

The first dispersion provided in step a1) comprises for example in the range from 0.5 to 30 wt % of the at least one clay mineral (C), in the range from 40 to 94.5 wt % of the dispersion medium, and in the range from 5 to 59.5 wt % of the at least one monomer, based in each case on the sum of the weight percentages of the at least one clay mineral (C), of the dispersion medium, and of the at least one monomer, preferably based on the overall weight of the first dispersion.

The first dispersion preferably comprises in the range from 0.5 to 20 wt % of the at least one clay mineral (C), in the range from 50 to 89.5 wt % of the dispersion medium, and in the range from 10 to 49.5 wt % of the at least one monomer, based in each case on the sum of the weight percentages of the at least one clay mineral (C), of the dispersion medium, and of the at least one monomer, preferably based on the overall weight of the first dispersion.

The first dispersion more preferably comprises in the range from 0.5 to 15 wt % of the at least one clay mineral (C), in the range from 60 to 84.5 wt % of the dispersion medium, and in the range from 15 to 39.5 wt % of the at least one monomer, based in each case on the sum of the weight percentages of the at least one clay mineral (C), of the dispersion medium, and of the at least one monomer, preferably based on the overall weight of the first dispersion.

Furthermore, the first dispersion may comprise additional components. Examples of such additional components are initiators or comonomers to the at least one monomer.

Suitable initiators are known as such to the skilled person and are selected fittingly for the at least one monomer. Examples of suitable initiators are ammonium peroxodisulfate (APS), potassium peroxodisulfate (KPS), azadiisobutyronitrile (AIBN), dibenzoyl peroxide (DBPO), or N,N,N′,N′-tetramethylethylenediamine (TEMEDA).

The first dispersion comprises the at least one monomer customarily in solution in the dispersion medium. Where additional components are present in the dispersion, they are customarily likewise in solution in the dispersion medium. The at least one clay mineral (C) is customarily in suspension in the solution of the dispersion medium and in the at least one monomer and also, optionally, the additional components. The dispersion medium with the dissolved at least one monomer and, optionally, the additional components then forms the dispersion medium, also called continuous phase, and the at least one clay mineral (C) forms the disperse phase, also called inner phase.

The at least one clay mineral (C) may be present in swollen or unswollen state in the first dispersion in step a1). Preferably the at least one clay mineral (C) is present in a swollen state.

Another subject of the present invention, therefore, is a method wherein the at least one clay mineral (C) is in swollen state in the first dispersion in step a1).

It is preferred, moreover, that for the purpose of providing the first dispersion in step a1), the at least one clay mineral (C) is first swollen in water and subsequently the at least one monomer and also, optionally, the additional components are added to this dispersion, comprising water and the swollen at least one clay mineral (C).

It is possible, moreover, that for providing the first dispersion in step a1), first of all the at least one clay mineral (C) is swollen in water and subsequently the swollen at least one clay mineral (C) is added to the dispersion medium, to the at least one monomer, and, optionally, to the additional components.

In step a2), the at least one monomer present in the first dispersion provided in step a1) is polymerized in the first dispersion. This gives the at least one thermoresponsive polymer (A), producing a second dispersion which comprises the at least one clay mineral (C), the dispersion medium, and the at least one thermoresponsive polymer (A).

The polymerization of the at least one monomer to give the at least one thermoresponsive polymer (A) is known as such to the skilled person.

The second dispersion obtained in step a2) comprises the at least one clay mineral (C), the dispersion medium, and the at least one thermoresponsive polymer (A).

For example, the second dispersion comprises in the range from 0.5 to 30 wt % of the at least one clay mineral (C), in the range from 40 to 94.5 wt % of dispersion medium, and in the range from 5 to 59.5 wt % of the at least one thermoresponsive polymer (A), based in each case on the sum of the weight percentages of the at least one clay mineral (C), the dispersion medium, and the at least one thermoresponsive polymer (A), preferably based on the overall weight of the second dispersion.

Preferably, the second dispersion comprises in the range from 1 to 20 wt % of the at least one clay mineral (C), in the range from 49.5 to 94 wt % of dispersion medium, and in the range from 5 to 49.5 wt % of the at least one thermoresponsive polymer (A), based in each case on the sum of the weight percentages of the at least one clay mineral (C), the dispersion medium, and the at least one thermoresponsive polymer (A), preferably based on the overall weight of the second dispersion.

More preferably, the second dispersion comprises in the range from 1 to 15 wt % of the at least one clay mineral (C), in the range from 59.5 to 94 wt % of dispersion medium, and in the range from 5 to 39.5 wt % of the at least one thermoresponsive polymer (A), based in each case on the sum of the weight percentages of the at least one clay mineral (C), the dispersion medium, and the at least one thermoresponsive polymer (A), preferably based on the overall weight of the second dispersion.

Furthermore, the second dispersion customarily further comprises the additional components which were present in the first dispersion. It is also possible for the second dispersion still to include residues of the at least one monomer.

The sum of the weight percentages of the at least one clay mineral (C), the dispersion medium, and the at least one thermoresponsive polymer (A) that are present in the second dispersion, and also, optionally, of the additional components, customarily makes 100 wt %.

If the second dispersion includes additional components, they are customarily in solution in the dispersion medium.

The at least one clay mineral (C) and the at least one thermoresponsive polymer (A) are customarily in suspension in the dispersion medium within the second dispersion. In that case the dispersion medium forms the dispersion medium, also called continuous phase, and the at least one clay mineral (C) and the at least one thermoresponsive polymer (A) form the disperse phase, also called internal phase.

The at least one clay mineral (C) and the at least one thermoresponsive polymer (A) may be present separately from one another in the second dispersion. It is also possible, and preferred in accordance with the invention, for the at least one clay mineral (C) and the at least one thermoresponsive polymer (A) to be present as a mixture in the second dispersion.

Where the at least one clay mineral (C) and the at least one thermoresponsive polymer (A) are present as a mixture, it is preferred for the at least one thermoresponsive polymer (A) to be applied on the surface of the at least one clay mineral and/or for the at least one clay mineral (C) to be applied on the surface of the at least one thermoresponsive polymer (A).

It is also preferred in accordance with the invention for the at least one clay mineral (C) to be present in a swollen state during the polymerization in step a2).

Another subject of the present invention is therefore a method wherein the at least one clay mineral (C) is present in a swollen state during the polymerization in step a2).

In step a3), the second dispersion obtained in step a2) is dried to give the mixture (M).

The second dispersion obtained in step a2) may be dried by any methods known to the skilled person—for example, by means of spray drying, centrifugation, drying at room temperature, under reduced pressure, or at elevated temperatures. Combinations are of course also possible. The dispersion obtained in step a2) is dried preferably by spray drying.

Another subject of the present invention is therefore a method wherein the second dispersion is dried by spray drying in step a3) to give the mixture (M).

It is therefore preferred that the providing of the mixture (M) in step a) comprises spray drying of the at least one thermoresponsive polymer (A) in the presence of the at least one clay mineral (C).

Another subject of the present invention is therefore a method wherein the providing of the mixture (M) in step a) comprises spray drying of the at least one thermoresponsive polymer (A) in the presence of the at least one clay mineral (C).

Methods for spray drying are known as such to the skilled person.

In step b), the mixture (M) is mixed with component (B) to give the composite material. The mixture (M) may be mixed with the component (B) by any methods known to the skilled person.

For example, the mixture (M) and component (B) may be mixed dry with one another; also possible is for mixture (M) to be predispersed in water and/or for component (B) to be first mixed with water, the two constituents then being mixed with one another. This embodiment is preferred.

For use as building material, especially as a binder, component (B) is customarily first mixed with water, and subsequently, for example, poured into a mold, applied as plaster to a wall and/or introduced into interstices in masonry. Component (B) is then cured, in the course of which it sets and becomes solid. It is therefore preferred in accordance with the invention for the mixture (M) to be mixed in step b) with component (b) and water to give a mixture. This mixture is then cured to give the composite material.

As described above, “setting” and “curing” are understood to refer to the transition from the liquid to the solid state, the transition to the solid state being attributable to chemical reactions. To the skilled person, therefore, it is clear that the composite material may comprise component (B) and optionally also components (A) and (C) in cured form and therefore in reacted form.

The mixing of the mixture (M) with component (B) and the water may take place by any methods known to the skilled person.

It is possible, for example, first to carry out premixing of the mixture (M) with the component (B), each of them dry, and then to mix this premix with water to give the mixture.

It is possible, moreover, for the mixture (M) to be added dry to a mixture which already contains component (B) and water.

It is likewise possible for the mixture (M) to be present in the form of a dispersion in water and for component (B) to be present in the form of a mixture in water, these constituents then being mixed. In this embodiment, the above-described step a3), in other words the drying of the second dispersion obtained in step a2), to give the mixture (M), is customarily not carried out. Instead, the second dispersion is mixed with component (B) as a mixture with water, preferably directly.

It is possible, furthermore, for the mixture (M) to be present in the form of a dispersion in water and for this dispersion then to be mixed with component (B), which is in dry form, to give the mixture. This mixture may then optionally be admixed with further water. In this embodiment, the above-described step a3), in other words the drying of the second dispersion obtained in step a2), to give the mixture (M), is customarily not carried out. Instead, the second dispersion is mixed with the dry component (B), preferably directly.

If the mixture (M) is used as a dispersion in water—if, therefore, preferably, the second dispersion is used and, in one preferred embodiment, the mixture (M) comprises component (C)—it is preferred for component (C) in step b) to be present in a swollen state.

Another subject of the present invention is therefore a method wherein the mixture (M) comprises component (C), and in step b) the component (C) present in the mixture (M) is in a swollen state.

When the mixture (M), the component (B), and the water have been mixed, the resulting mixture can be cured to give the composite material.

### Use of the Composite Material

The composite material of the invention may be used in particular in areas where there is a need for external or internal cooling and/or in which the atmospheric humidity is to be regulated. The composite material of the invention is used preferably for the cooling of buildings or of outdoor facilities. In this case the composite material of the invention may be applied on the outer walls or incorporated into facades, in order to cool the outer walls of buildings. A further possible application is inside buildings; here, the composite material can be used for cooling and for moisture management of interiors. A further possible application relates to the cooling of outdoor facilities. In this context, the composite material of the invention can be incorporated into floor coverings or road coverings, into roofs, into construction elements or into boundary walls. A further possible application relates to the cooling of electrical systems and assemblies, of primary or secondary batteries, of infrastructure stations and warehouses which are operated self-sufficiently, and/or for regulating the atmospheric humidity in interior spaces of buildings or of outdoor facilities.

The composite material of the invention is therefore used preferably for cooling buildings, interiors, electrical assemblies, primary batteries or secondary batteries, outdoor facilities, exterior facades and/or for regulating the humidity in interiors of buildings.

Another subject of the present invention is therefore the use of a composite material for cooling buildings, interiors, electrical assemblies, primary batteries or secondary batteries, outdoor facilities, exterior facades and/or for regulating the humidity in interiors of buildings.

It is thought that the composite materials of the invention take on water below the lower critical solution temperature (LCST) of component (A). For example, the composite materials of the invention take up sufficient water for the weight ratio of the water taken up, relative to the composite material, to be in the range from 5:100 to 300:100, preferably in the range from 10:100 to 200:100, and especially preferably in the range from 20:100 to 100:100.

The water taken up by the composite material may be taken up, for example, from the surrounding environment, customarily in the form of precipitation or of atmospheric moisture. It is also possible for the composite material to be deliberately wetted with water. Preferably the composite material takes up the water from the surrounding environment.

If the temperature rises to the lower critical solution temperature (LCST) of component (A) or above, then the composite material gives up water, which through capillary forces is distributed uniformly in the at least one inorganic building material of the composite material and, as a result of the increased surface area, allows optimum evaporation of the water. The heat of evaporation required for this purpose is taken from the surrounding environment, and therefore the composite material cools down and the adjacent surroundings do likewise.

The present invention is elucidated in more detail below by means of examples.

### EXAMPLES

Preparation of a Mixture (M) from Components (A) and (C)

The following components were used:

### Monomers:

N-Isopropylacrylamide (NiPAAm) from Wako Chemicals and from TCI Chemicals
N,N′-Methylenebisacrylamide (BIS) from AppliChem and Merck KGaA
[3-(Methacryloylamino)propyl]trimethylammonium chloride solution (MAPTAC; 50 wt % in water) from ABCR GmbH

### Clay Mineral:

Sodium bentonite: EXM757 from Süd-Chemie

### Initiators:

N,N,N′,N′-Tetramethylethylenediamine (TEMEDA) from ABCR GmbH
Potassium peroxodisulfate (KPS) from Fluka
Ammonium peroxodisulfate (APS) from Grüssing GmbH Analytica

Sodium bentonite (162 g, 113 mmol of sodium) was swollen in deionized water (2 l). Then further deionized water was added, giving the dispersion a volume of 12 liters in total. NiPAAM (1000 g, 8840 mmol), BIS (50 g, 324 mmol, 5 wt % based on NiPAAM), and MAPTAC (50 g of a 50 wt % strength solution in water, 113 mmol, 5 wt % based on NiPAAM) were added to the dispersion, to give the first dispersion. After devolatilization with nitrogen, the first dispersion was heated to 80° C. and KPS (20 g, 74 mmol, 2 wt % based on NiPAAM) was added in order to initiate the polymerization of the monomers. The polymerization was carried out at 80° C. for 6 hours. After cooling had taken place, 5 liters of deionized water were added in order to reduce the viscosity of the resulting second dispersion. The particles of the mixture (M) present in the second dispersion had a diameter in the range from 1 to 2 mm. The water fraction of the second dispersion was 90 wt %, based on the overall weight of the second dispersion.

The second dispersion was subsequently dried by different methods.

### a) Spray Drying of the Second Dispersion

Spray drying was carried out using a Nubilosa® LTC-ME laboratory spray dryer. The entry temperature was set at 165° C., the exit temperature was regulated at 85 to 90° C. by means of the injected second dispersion. The second dispersion was atomized with compressed air (5 bar) through a two-component nozzle (diameter 2 mm). The residual moisture content of the resulting mixture (M) was 3 wt %. The mixture (M) obtained by spray drying is referred to below as (M-S).

### b) Centrifugation and Subsequent Drying at Room Temperature

The resulting second dispersion was centrifuged at 4200 rpm in a CEPA LS laboratory centrifuge with a polyamide filter bag. The resulting mixture was subsequently dried at room temperature for 5 days and finally ground. The residual moisture content of the mixture (M) obtained was 6 wt %. The mixture (M) obtained by centrifugation and subsequent drying at room temperature is referred to below as (M-C).

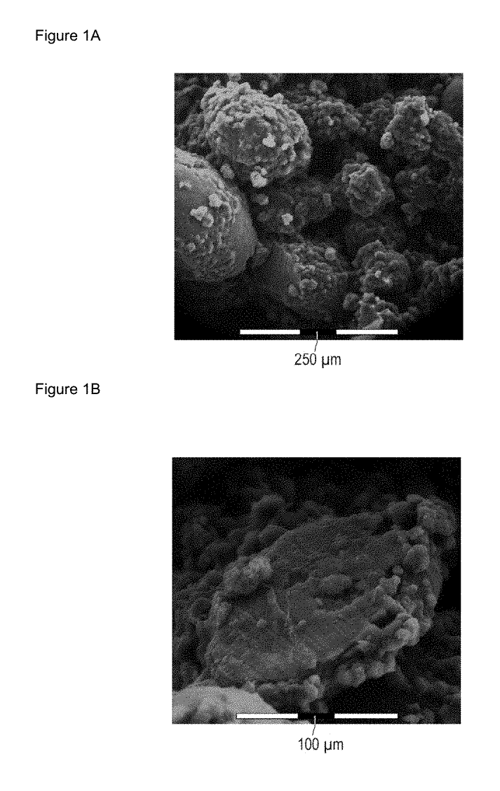

In order to determine the morphology of the particles present in M-S and M-C, the particles were analyzed by environmental scanning electron microscopy (ESEM 2020 from ElectroScan), equipped with a GSED (gaseous secondary electron detector). The results are shown in FIGS. 1a and 1b for (M-S) and 2a and 2b for (M-C).

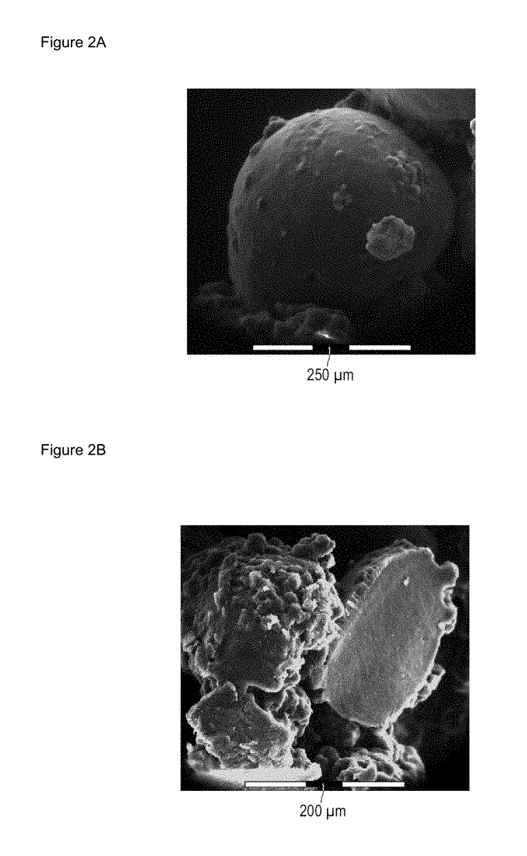

It can be seen that significantly smaller particles having a diameter of around 100 μm are obtained by the spray drying (FIGS. 1a and 1b), in comparison to centrifuged and subsequently dried particles, whose diameter is around 300 μm (FIGS. 2a and 2b). The particles of the clay mineral are disposed on the surface of the thermoresponsive polymer.

### Composite Material

The composite material and the comparative materials were produced using the following components:

### Mixture (M):

M-S (spray-dried)

### Component (B)

B-a: Portland cement, CEM I 52.5, from Schwenk, Mergelstetten
B-b: Cement mortar: 11 g Portland cement, 32.9 g sand aggregate (EN 196-1 standard sand) and 6.1 g water
B-c: Gypsum binder: 50 g α-hemihydrate gypsum binder (Knauf A4FF AHH), 45 g water and 0.3 g Starvis® S 3911 F (BASF) stabilizer/thickener
B-d: Geopolymer mortar: 11.1 g metakaolin (Metamax, BASF SE), 25 g silica sand BCS 319 (Strobel Quarzsand GmbH), 14 g potassium silicate K45 M (Woellner, Ludwigshafen) and 6 g water

To produce a composite material comprising component B-a, the dry mixture (M) was mixed with the dry component B-a, followed by addition of water, further thorough mixing, the introduction of the mixture into a circular wooden mold with a diameter of 4 cm and a height of 2 cm, and the curing of the composite material at room temperature for 24 hours. The material was then removed from the mold and the disks were surface-polished on both sides to a thickness of 1 cm. These circular disks were used as sample specimens in the measurements described below.

The amounts of component B-a, water and the mixture (M) used are reported in table 1.

TABLE 1

| | | | | | Component (A) |
|---|---|---|---|---|---|
| | Cement | | | M-S | based on |
| | (B-a) | Water | M-S | [wt % | composite |
| Example | [g] | [ml] | [g] | based on cement] | material (wt %) |
| V1 | 30 | 15 | — | — | 0 |
| V2 | 30 | 15 | 0.3 | 1 | 0.9 |
| V3 | 30 | 20 | 1.5 | 5 | 4.2 |
| B4 | 30 | 50 | 3.0 | 10 | 7.9 |
| B5 | 24 | 55 | 7.9 | 30 | 21.6 |
| B6 | 20 | 60 | 10 | 50 | 29.1 |
| B7 | 15 | 60 | 9.0 | 60 | 32.7 |
| B8 | 7.5 | 60 | 5.6 | 75 | 37.3 |
| V18 | 7.5 | 60 | 8.5 | 113 | 46.3 |
| V19 | 6 | 60 | 10 | 167 | 54.5 |

The sample specimens produced as described above were first of all weighed, then introduced into deionized water and, after 2 hours and also after 24 hours, removed and weighed. The water absorption, determined as an average value from four measurements, corresponded to the weight increase after drip-drying of the sample specimens, minus the original dry weight of the sample. The water content of the sample specimens was then calculated relative to the total weight of the sample, in wt %.

The water content of the various sample specimens is reported in table 2.

TABLE 2

| | Water content after 2 h | Water content after 24 h |
|---|---|---|
| | [wt. %] | [wt. %] |
| V1 | 22 | 33 |
| V2 | 23 | 36 |
| V3 | 28 | 45 |
| B4 | 35 | 50 |
| B5 | 51 | 75 |
| B6 | 54 | 72 |
| B7 | 52 | 70 |
| B8 | 50 | 66 |

For assessing the suitability of the composite materials for cooling, especially of buildings, the rate of absorption of water and therefore the water content after 2 hours are of great importance. Suitable materials for cooling must absorb an extremely large amount of water within a short time in order to be able to be employed efficiently for cooling.

It is evident that the comparison materials in comparative examples V1 to V3 exhibit a much lower water absorption than the inventive composite materials of examples B4 to B8. It is also evident that the rise in the water content after two hours correlates with the fraction of the mixture (M) in the composite material, and that a maximum in the absorption capacity is achieved in the case of examples B5 and B6.

The composite materials of comparative examples V18 and V19 were not dimensionally stable, and disintegrated on swelling in water. No useful shaped articles were obtained, therefore.

### Passive Cooling

For determination of the passive cooling behavior, the sample specimens produced as described above were placed at an angle of 40° and at a distance of 35 cm from an infrared lamp (500 W halogen). A constant stream of air was passed over the sample specimens at a flow rate of 0.1 m/s. An infrared camera was used to determine the temperature profile on the surface of the materials.

In order to determine the change in water content, the sample specimens were placed on a balance and the weight of the sample specimens was determined as a function of time.

In order to determine the cooling effect of the materials, the sample specimens were each placed on a cut-to-size panel of a rigid polyurethane foam material (Kingspan™ Therma TF70 insulated flooring panel, dimensions 10×10 cm, thickness 3 cm) and, between the panel of rigid polyurethane foam material and the sample specimen, a thermocouple was introduced, which determines the temperature on the reverse of the sample specimen.

### a) Surface Temperature and Water Content

The surface temperatures and also the water content of the composite material of example B6 and of the comparison material of comparative example V1 were determined over a period of 300 minutes. The initial water content of the samples (72 wt % for B6 and 33 wt % for V1; see table 2) was set at 100% in each case, and the percentage decrease in weight of both samples over time was monitored.

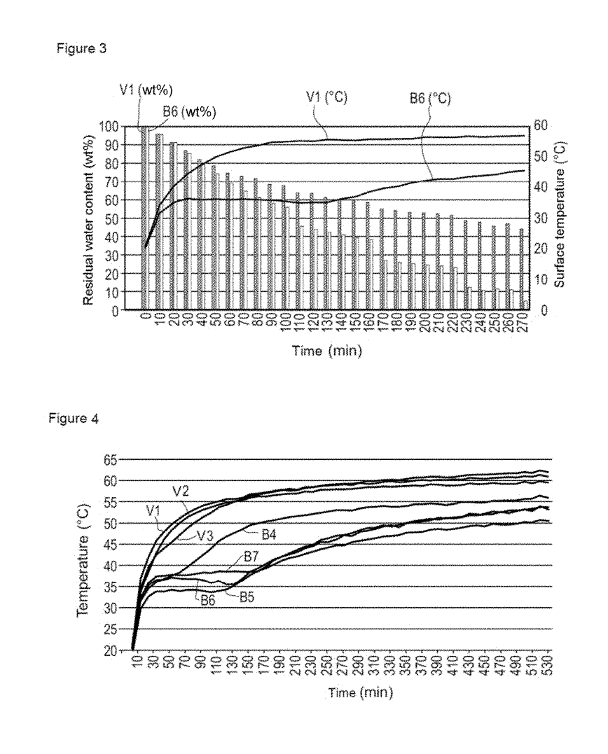

FIG. 3 shows the results of this test.

It can be seen that at the start of the measurement, the rate of evaporation of the water is identical in both examples B6 and V1. After about 30 minutes, however, already more water has evaporated from the composite material of example B6. Over the entire measurement period, more water evaporates from the composite material of example B6 than from the comparison material of comparative example V1, and so a smaller percentage water content is left in the case of example B6. At the same time, owing to the greater rate of evaporation, the inventive composite material B6 exhibits a lower surface temperature and hence a greater cooling effect. The higher cooling effect of the composite material of the invention derives from the fact that it is able to take up greater amounts of water, but then also gives up this water again more willingly. This effect is much less pronounced in the comparison material, where, additionally, the water is given up less willingly to the surrounding environment.

### b) Passive Cooling

For the determination of the passive cooling behavior, the surface temperature of the different composite materials was determined over a period of 530 minutes. Prior to measurement, all of the samples were swollen in deionized water for 24 hours (see table 2).

At the start of measurement, the surface temperature of all the materials increases very sharply. After 90 minutes the material of comparative example V1 has a temperature of around 55° C., while the inventive composite materials exhibit only a temperature of around 33° C. up to a maximum of 38° C. In the case of the inventive composite materials, this temperature is maintained for 60 to 170 minutes. The cooling effect, in other words the duration of the holding of the temperature in the range from 33 to a maximum of 38° C., correlates directly with the fraction of mixtures (M) in the composite materials. The plateau at the lowest temperature is obtained for example B5.

### c) Two-Layer Measurements

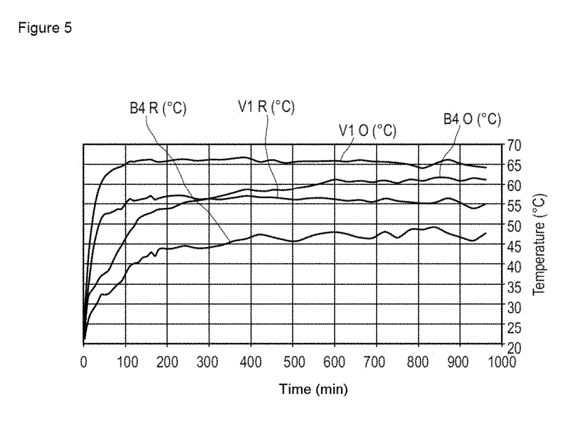

The two-layer measurements were conducted as described above. FIG. 5 shows the surface temperature (O) and also the reverse temperature (R) of the composite material B4 and of the comparison material V1 over the measuring period of 960 minutes.

It is evident that not only the surface temperature but also the reverse temperature of the inventive composite material B4 are much lower than the respective temperatures of the comparison material V1. With the inventive composite material, therefore, a higher cooling effect is obtained than with the comparison material.

### Passive Cooling Behavior of Composite Materials Comprising Components B-b to B-d

For producing a composite material comprising components B-b to B-d, the dry mixture (M) was mixed with the dry component B-b, B-c or B-d. The amount of mixture (M) added in each case was such that the composite material contained 10 wt % of the mixture (M), based on component B. Thereafter water was added, the constituents were mixed thoroughly, the mixture was introduced into a wooden mold having a diameter of 4 cm and a height of 3 cm, and the composite material was cured for 12 hours at room temperature and 65% humidity and also for a further 12 hours at 50° C. in a drying cabinet. The composite materials were subsequently removed from the mold, and the disks were surface-polished on both sides to a thickness of 2 cm. These disks were used as sample specimens in the measurements described below.

The sample specimens were first of all weighed, then placed in deionized water and, after 24 hours, taken out and weighed again. The water absorption, determined as the average value from four measurements, corresponded to the weight increase after drip-drying of the sample specimens, minus the original dry weight of the sample. The water content of the sample specimens was then calculated in relation to the total weight of the sample, in wt %.

The composition of the composite materials and water content after 24 h are reported in table 3.

TABLE 3

| | | M-S | Water content after 24 h |
|---|---|---|---|
| Example | Component B | [wt %] | [wt %] |
| V9 | Cement mortar (B-b) | 0 | 7.5 |
| B10 | Cement mortar (B-b) | 10 | 33.6 |
| V11 | Gypsum binder (B-c) | 0 | 60.5 |
| B12 | Gypsum binder (B-c) | 10 | 90.3 |
| V13 | Geopolymer mortar (B-d) | 0 | 21.9 |
| B14 | Geopolymer mortar (B-d) | 10 | 36.1 |

Here as well it is evident that comparison materials V9, V11 and V13 exhibit a much lower water absorption than the inventive composite materials of examples B10, B12 and B14.

The composite materials were additionally investigated for their passive cooling behavior. For this purpose, holes with a diameter of 39 mm were punched from an Aerogel panel measuring 40×40×2 cm and having a low thermal conductivity (0.019 W/mK, Slentex Aerogel, BASF Polyurethanes GmbH), and the sample specimens of composite materials B10, B12 and B14 and also the comparative sample specimens V9, V11 and V13 were introduced into the holes. The surface of the experimental arrangement was lit with a 500 W halogen lamp and the underside was observed with an infrared camera for determination of the reverse temperatures. Before being introduced into the aerogel, the composite materials were swollen completely in water for 24 hours as described above. The lighting time was 300 minutes; the temperatures on the reverse of specimens V9 and B10, V11 and B12 and V13 and B14 were determined at the end of the measurement time, and a calculation made of the temperature difference between the pairs of values. At the end of the measurements, the inventive composite materials had the lower reverse temperatures in each case. The results can be seen in table 4.

TABLE 4

| | | Temperature |
|---|---|---|
| | Sample specimens | difference |
| Example | in comparison | (° C.) |
| B15 | V9-B10 | 6.4 |
| B16 | V11-B12 | 5.6 |
| B17 | V13-B14 | 2.1 |

1. A composite material which comprises the components
(A) at least one thermoresponsive polymer and
(B) at least one inorganic building material,
the composite material further comprising a component (C), at least one clay mineral, wherein the component (C) is not a binder,
the component (A) having a lower critical solution temperature (LCST), the lower critical solution temperature (LCST) being in the range from 5 to 70° C., and
the component (B) being selected from the group consisting of hydraulically setting binders and nonhydraulically setting binders,
wherein the composite material comprises in the range from 5 to 45 wt % of component (A), in the range from 10 to 94.9 wt % of component (B), and in the range from 0.1 to 45 wt % of component (C), based in each case on the sum of the weight percentages of components (A), (B), and (C).

2. The composite material according to claim 1, wherein component (A) is selected from the group consisting of poly(meth)acrylates, poly(meth)acrylamides, poly(meth)acryloylpyrrolidines, poly(meth)acryloylpiperidines, poly-N-vinylamides, polyoxazolines, polyvinyloxazolidones, polyvinylcaprolactones, polyvinylcaprolactams, polyethers, hydroxypropylcelluloses, polyvinyl ethers, and polyphosphoesters.

3. The composite material according to claim 1, wherein component (C) is selected from the group consisting of montmorillonites and kaolinites.

4. The composite material according to claim 1, wherein the composite material comprises in the range from 10 to 40 wt % of component (A), in the range from 20 to 89.5 wt % of component (B), and in the range from 0.5 to 20 wt % of component (C), based in each case on the sum of the weight percentages of components (A), (B), and (C).

5. The composite material according to claim 1, wherein the composite material comprises at least one component (D), at least one organic binder.

6. A method for producing a composite material according to claim 1, comprising the steps of
a) providing a mixture (M) which comprises the at least one thermoresponsive polymer component (A),
b) mixing the mixture (M) with component (B) to give the composite material,
wherein the mixture (M) provided in step a) further comprises at least one clay mineral component (C).

7. The method according to claim 6, wherein the providing of the mixture (M) in step a) comprises a polymerization of at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters, to give the at least one thermoresponsive polymer component (A).

8. The method according to claim 6, wherein the providing of the mixture (M) in step a) comprises the following steps:
a1) providing a first dispersion which comprises the at least one clay mineral component (C), a dispersion medium selected from the group consisting of water and an organic solvent, and at least one monomer selected from the group consisting of (meth)acrylates, (meth)acrylamides, (meth)acryloylpyrrolidines, (meth)acryloylpiperidines, N-vinylamides, oxazolines, vinyloxazolidones, vinylcaprolactones, vinylcaprolactams, alkylene oxides, vinyl ethers, and phosphoesters,
a2) polymerizing the at least one monomer present in the first dispersion provided in step a1), in the first dispersion, to give the at least one thermoresponsive polymer component (A), to give a second dispersion which comprises the at least one clay mineral component (C), the dispersion medium, and the at least one thermoresponsive polymer component (A),
a3) drying the second dispersion obtained in step a2) to give the mixture (M).

9. The method according to claim 6, wherein the providing of the mixture (M) in step a) comprises a spray drying of the at least one thermoresponsive polymer component (A) in the presence of the at least one clay mineral component (C).

10. The method according to claim 6, wherein the mixture (M) provided in step a) comprises the at least one thermoresponsive polymer component (A) in the form of particles and comprises the at least one clay mineral component (C) in the form of particles, the particles of the at least one thermoresponsive polymer component (A) having a D50 in the range from 200 nm to 5 mm, and the particles of the at least one clay mineral component (C) having a D50 in the range from 50 nm to 3 mm, determined by light scattering and/or sieving.

11. A method comprising utilizing the composite material according to claim 1 for at least one of cooling buildings, interiors, electrical assemblies, primary batteries or secondary batteries, outdoor facilities, and exterior facades, and regulating the humidity in interiors of buildings by applying the composite material thereon or incorporating the composite material therein.
